(19) United States
(12) Patent Application Publication
(10) Pub. No.: US 2024/0395165 A1
(43) Pub. Date: Nov. 28, 2024

(54) METHOD AND SYSTEM FOR IDENTIFICATION AND CLASSIFICATION OF ERRORS IN A SUBMITTED SOLUTION

(71) Applicant: SIT Programming School AG, Schaffhausen (CH)

(72) Inventors: Sergey Shedov, Madrid (ES); Ivan Dobrosovestnov, Belgrade (RS); Semen Obukhov, Belgrade (RS); Serg Bell, Singapore (SG); Stanislav Protasov, Singapore (SG)

(21) Appl. No.: 18/324,641

(22) Filed: May 26, 2023

(51) Int. Cl. G09B 19/00; G06F 16/901

(52) U.S. Cl. CPC G09B 19/0053; G06F 16/9024

(57) ABSTRACT

Methods and systems for identification and classification of errors in a submitted solution. A method includes generating a graph representation of the plurality of pre-selected error-free solutions and the submitted solution. Graph representation of an error-free solution from the plurality of pre-selected error-free solutions is selected with the minimal distance from the graph representation of the submitted solution. The graph representation of the submitted solution is compared to that of the selected error-free solution. The difference between the graph representations is then identified. The differences are then mapped to the submitted solution and the selected error-free solution. Using a graphical user interface, the difference between the submitted solution and the selected error-free solution are displayed as an explanation of an error in the submitted solution.

### TECHNICAL FIELD

The present disclosure generally relates to the field of education. In particular, the present disclosure relates to identification and classification of errors in a solution submitted by a subject for a review.

### BACKGROUND

In many educational institutions and systems, the key element of education is teaching a student the ability to solve problems. In such environments, each student can have more than one attempt to submit a solution to a given problem. For example, a software development student may submit his code for review, testing, and ultimately, grading.

When a solution is submitted by a subject, for example, a student or a job applicant, the reviewing party must typically manually review the submission. As a task may have multiple error-free solutions, it is often hard to simply compare the structure of the student's solution to one or even many previously collected error-free solutions using any of the existing code comparison tools.

Thus, there is a need for automatically reviewing a solution submitted by a subject and automatically identifying and classifying one or more errors within that solution.

### SUMMARY

Embodiments described herein include a method for identification and classification of errors in a submitted solution using a collection of pre-selected error-free solutions. A method includes generating a graph representation of the plurality of pre-selected error-free solutions and a graph representation of the submitted solution, in any order; selecting a graph representation of an error-free solution from the plurality of pre-selected error-free solutions with a minimal distance from the graph representation of the submitted solution; comparing the graph representation of the submitted solution to the graph representation of the selected error-free solution; identifying a difference between the graph representation of the submitted solution and the graph representation of the selected error-free solution; mapping the difference between the graph representation of the submitted solution and the graph representation of the selected error-free solution to the submitted solution to source code fragments from the submitted solution and the selected error-free solution from which the nodes and edges comprising the difference were generated; and displaying, using a graphical user interface, the difference between the submitted solution and the selected error-free solution as an explanation of an error in the submitted solution.

In one aspect, the distance between graphs is the Graph Edit Distance (GED).

In one aspect, selecting the graph representation of the selected error-free solution further comprises using a thinning algorithm to select the graph representation of the selected error-free solution.

In one aspect, identifying the difference between the graph representation of the submitted solution and the graph representation of the selected error-free solution further comprises assigning a score to the submitted solution.

In one aspect, the score is in inverse correlation with the number of differences between the graphs of the submitted solution and the selected error-free solution.

In one aspect, the graph of the software source code is at least one of an Abstract Syntax Tree (AST), a Control Flow Graph (CFG), a Program Dependence Graph (PDG), and a Code Property Graphs (CPG).

In one aspect, identifying the difference between the graph representations of the submitted solution and the graph representation of the selected error-free solution further comprises classifying the errors based on prior classification of errors using at least one of a machine learning artificial intelligence (AI) system and an expert AI system.

In an embodiment, a system for identification and classification of errors in a submitted solution using a collection of pre-selected error-free solutions includes at least one processor and a memory operably coupled to the at least one processor; a graph representation (GR) generator including instructions that, when executed by the at least one processor, cause the processor to generate a graph representation of the plurality of pre-selected error-free solutions and the submitted solution; a selector including instructions that, when executed by the at least one processor, cause the processor to select graph representation of an error-free solution from the plurality of pre-selected error-free solutions with a minimal distance from the graph representation of the submitted solution; a comparator including instructions that, when executed by the at least one processor, cause the processor to compare the graph representation of the submitted solution to the graph representation of the selected error-free solution; and a result computing unit including instructions that, when executed by the at least one processor, cause the processor to: identify a difference between the graph representation of the submitted solution and the graph representation of the selected error-free solution; map a difference between the graph representations of the submitted solution and the graph representation of the selected error-free solution to source code fragments from the submitted solution and the selected error-free solution from which the nodes and edges comprising the difference were generated; and display, using a graphical user interface, the difference between the submitted solution and the selected error-free solution as an explanation of an error in the submitted solution.

In one aspect, the submitted solution is a computer source code.

In one aspect, the selector is further configured to use a thinning algorithm to select the graph representation of the selected error-free solution.

In one aspect, a system further comprises a score generator including instructions that, when executed by the at least one processor, cause the processor to assign a score to the submitted solution.

In one aspect, a system further comprises a classifier including instructions that, when executed by the at least one processor, cause the processor to classify the errors based on prior classification of errors using at least one of a machine learning artificial intelligence (AI) system and an expert AI system.

### BRIEF DESCRIPTION OF THE DRAWINGS

FIG. 1 is a block diagram of a system for identification and classification of errors in a submitted solution using a collection of pre-selected error-free solutions, in accordance with an embodiment.

FIG. 2 is a flowchart of a method for identification and classification of errors in a submitted solution using a collection of pre-selected error-free solutions, in accordance with an embodiment.

### DETAILED DESCRIPTION

One of the most important elements of education that many educational institutions and systems strive for is teaching a student the ability to solve problems. Certain embodiments of testing students allow students to submit multiple solutions to a test problem. For example, a software development student may submit his code for review, testing, and ultimately, grading. Similar submissions can be by non-student subjects, such as solutions submitted by a job applicant as part of a job interview process.

Embodiments can evaluate the submitted solution by testing the functionality of the code on a predefined set of testing data. Such tests, on top of checking the output of the system under test, can also evaluate the amount of resources the system consumes, and the amount of time it takes to complete the task.

In an example scenario, when a solution submitted by a subject fails the test, embodiments described herein avoid the problem of an examiner having to manually review the code for the purpose of identifying a possible error within that submitted code. Likewise, because a task may have multiple error-free solutions, and because it can often be hard to simply compare the structure of the submitted solution to one or even many previously collected error-free solutions using any of the existing code comparison tools, embodiments described herein reduce or eliminate manual review.

More specifically, embodiments described herein include systems and methods for identification and classification of errors in a submitted solution using a collection of pre-selected error-free solutions.

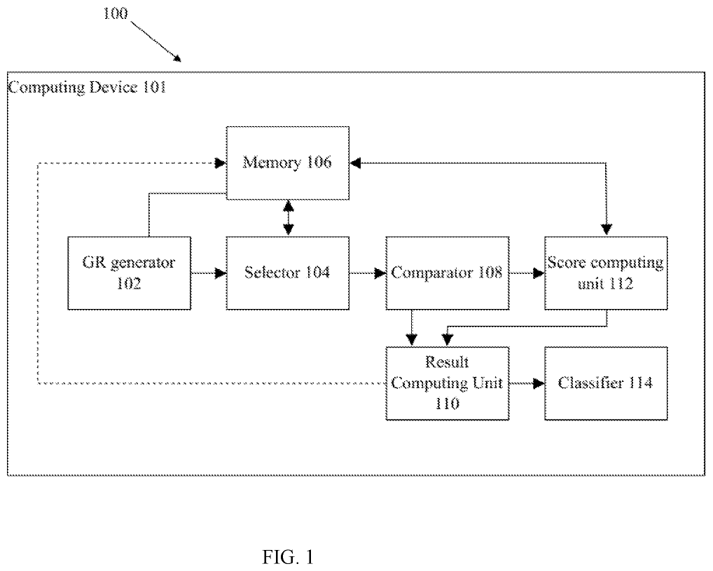

FIG. 1 is a block diagram of a system 100 for identification and classification of errors in a submitted solution using a collection of pre-selected error-free solutions, in accordance with an embodiment. In accordance with an embodiment of the present disclosure, a solution submitted by a subject is converted into a graph representation thereof and compared with graph representations of the error-free solutions. The system 100 is executed on a computing device 101, in accordance with an embodiment of the present disclosure. Accordingly, computing device 101 can include at least one processor (not depicted in FIG. 1) and memory 106.

The at least one processor can be a programmable device that accepts digital data as input, is configured to process the input according to instructions or algorithms, and provides results as outputs. In an embodiment, the at least one processor can be a central processing unit (CPU) configured to carry out the instructions of a computer program. The at least one processor is therefore configured to perform at least basic arithmetical, logical, and input/output operations.

Memory 106 can comprise volatile or non-volatile memory as required by the coupled at least one processor to provide space to execute the instructions or algorithms, the space to store the instructions themselves, as well as any related data (for example, as will be described with the rest of the components of the system 100) In embodiments, volatile memory can include random access memory (RAM), dynamic random access memory (DRAM), or static random access memory (SRAM), for example. In embodiments, non-volatile memory can include read-only memory, flash memory, ferroelectric RAM, hard disk, floppy disk, magnetic tape, or optical disc storage, for example. The foregoing lists in no way limit the type of memory that can be used, as these embodiments are given only by way of example and are not intended to limit the scope of the invention.

The system can include various engines or modules, each of which is constructed, programmed, configured, or otherwise adapted, to autonomously carry out a function or set of functions. The term engine as used herein is defined as a real-world device, component, or arrangement of components implemented using hardware, such as by an application specific integrated circuit (ASIC) or field-programmable gate array (FPGA), for example, or as a combination of hardware and software, such as by a microprocessor system and a set of program instructions that adapt the engine to implement the particular functionality, which (while being executed) transform the microprocessor system into a special-purpose device. An engine can also be implemented as a combination of the two, with certain functions facilitated by hardware alone, and other functions facilitated by a combination of hardware and software. In certain implementations, at least a portion, and in some cases, all, of an engine can be executed on the processor(s) of one or more computing platforms that are made up of hardware (e.g., one or more processors, data storage devices such as memory or drive storage, input/output facilities such as network interface devices, video devices, keyboard, mouse or touchscreen devices, etc.) that execute an operating system, system programs, and application programs, while also implementing the engine using multitasking, multithreading, distributed (e.g., cluster, peer-peer, cloud, etc.) processing where appropriate, or other such techniques. Accordingly, each engine can be realized in a variety of physically realizable configurations and should generally not be limited to any particular implementation exemplified herein, unless such limitations are expressly called out. In addition, an engine can itself be composed of more than one sub-engines, each of which can be regarded as an engine in its own right. Moreover, in the embodiments described herein, each of the various engines corresponds to a defined autonomous functionality; however, it should be understood that in other contemplated embodiments, each functionality can be distributed to more than one engine. Likewise, in other contemplated embodiments, multiple defined functionalities may be implemented by a single engine that performs those multiple functions, possibly alongside other functions, or distributed differently among a set of engines than specifically illustrated in the examples herein.

In an embodiment, the submitted solution is a computer source code. The system 100 comprises a graph representation (GR) generator 102 configured to generate a graph representation of the plurality of pre-selected error-free solutions and the submitted solution. The graph representations are generated by the GR generator 102 for the purpose of achieving comparison therebetween for efficiently comparing the submitted solution to an error-free solution.

For example, the GR generator 102 can include a parser to parse the submitted computer source code. Accordingly, the GR generator 102 can further include a graphing tool to generate one or more graphs from the parsed computer source code. In an embodiment, a graph includes a set of nodes and edges that connect those nodes. Nodes can represent objects and edges that connect objects represent their relationship. Once parsed or during the process of parsing, the graphing tool can create one or more graphs to represent the computer source code. In embodiments, one or more nodes or edges can correspond to a particular code fragment.

For example, a graph can represent the syntactic structure of the computer source code in an Abstract Syntax Tree (AST). In another example, a graph can represent the order in which the computer source code is executed and conditions that need to be met for the computer source code in a Control Flow Graphs (CFG). In another example, a graph can represent data and control dependencies of the computer source code in a Program Dependence Graph (PDG). In embodiments, two or more of these types of graphs can be utilized or combined into a master graph. For example, two or more of the aforementioned graphs representing the respective different properties of the computer source code allows for the construction of a master graph that merges the different representations into a Code Property Graph (CPG). With a CPG, complex behaviors of the computer source code can be expressed in a single graph.

In an embodiment, a graph can be instantiated as a two dimensional integer array of size n×n, where n is the number of vertices in the graph: int[][] graph=new int[n][n]. In embodiments, a graph can be stored as an adjacency list, an adjacency matrix, or edge list.

The selection of the error-free solution is facilitated by a selector 104. The selector 104 is configured to select a graph representation of an error-free solution from the plurality of pre-selected error-free solutions with a minimal distance from the graph representation of the submitted solution. In an embodiment, each solution from the plurality of pre-selected error-free solutions can be marked to be error-free after, for example, a manual review by an instructor or by automated review such as by an AI code reviewer. Such solutions identified as error-free can comprise the pre-selected error-free solutions.

More specifically, the error-free solutions and graph representations thereof are fed into the memory 106 of the system 100. The selector 104 is configured to select graph representation of that error-free solution which has a minimal distance relative to the graph representation of the submitted solution. In an embodiment, the distance is calculated as the distance between the graph representation of the submitted solution and each graph representation from the plurality of pre-selected error-free solutions. In an embodiment, the distance between graphs is calculated using a Graph Edit Distance (GED).

In an embodiment, the selector 104 is further configured to use a thinning algorithm to select the graph representation of the selected error-free solution. In an embodiment, a thinning algorithm simplifies the graph representation of the solution by removing certain nodes or edges based on a predefined criteria. Examples of thinning using predefined criteria can include removing nodes and edges not in the largest connected component, smoothing vertices according to certain degrees, and removing nodes and edges that are not contained in a cycle (e.g. a dead end). In embodiments, thinning can include removing nodes and/or edges while retaining information contained in the discarded nodes or edges (such as in remaining nodes or edges). In other embodiments, thinning can include removing nodes and/or edges without retaining information contained in the discarded nodes or edges.

In accordance with an embodiment of the present disclosure, the graph representations of the submitted solution and the selected error-free solution are then compared by a comparator 108 to highlight the nodes and edges that exist in one graph representation and do not exist in the other, for example, induced by the Graph Edit Distance (GED) algorithm.

The system 100 further includes a result computing unit 110 configured to identify the difference between the graph representations of the submitted solution and the graph representation of the selected error-free solution. The result computing unit 110 is further configured to map the difference between the graph representations of the submitted solution and the graph representation of the selected error-free solution. In an embodiment, a map includes nodes and edges that exist in one solution and do not exist in the other to the specific source code fragments within the submitted solution and the selected error-free solution, respectively, from which these nodes and edges were originally generated in the process of creation of the graph representation of these solutions. The result computing unit 110 is further configured to, using a graphical user interface, display the difference between the submitted solution and the selected error-free solution as an explanation of an error in the submitted solution.

In an embodiment, the system 100 further comprises a score generator 112 configured to assign a score to the submitted solution with an inverse correlation on the distance between the graph of the submitted solution and the selected graph of an error-free solution. For example, a score including an inverse correlation may equal the number one divided by that distance.

In an embodiment, the system further comprises a classifier 114 configured to classify the errors based on prior classification of errors, where the classifier 114 is at least one of a machine learning artificial intelligence (AI) system, for example, the Naïve Bayes classifier, the k-nearest neighbors algorithm, or the Perceptron algorithm, and an expert AI system, wherein the expert AI system uses a predefined and preprogrammed algorithm to make the classification decision. In an embodiment, the memory 106 includes the dataset of error classifications for allowing the system 100 to compare the detected errors with the dataset of error classifications for classifying the detected errors. In another embodiment, the dataset of error classifications can be fed into classifier memory 106.

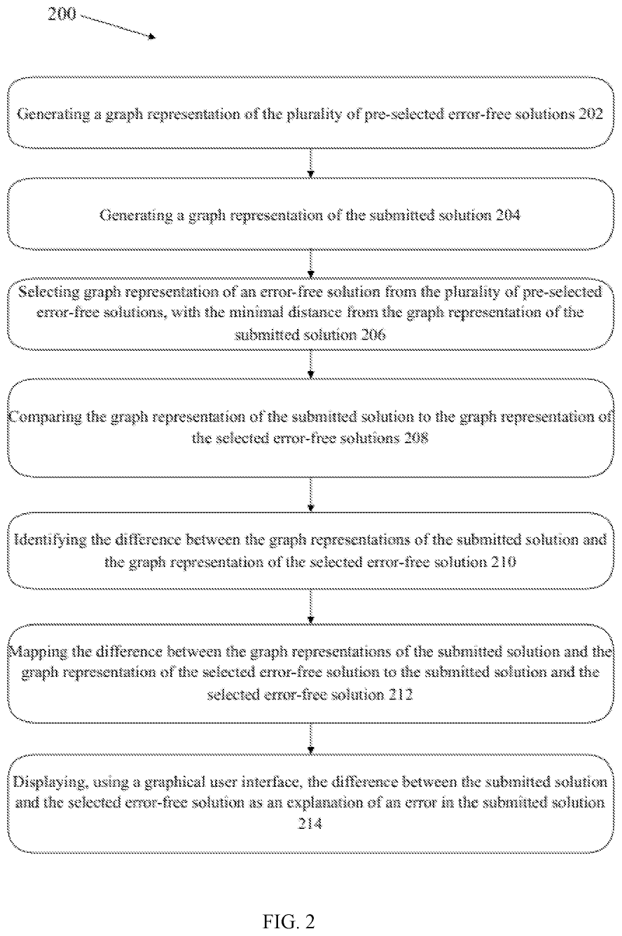

FIG. 2 is a flowchart of a method 200 for identification and classification of errors in a submitted solution using a collection of pre-selected error-free solutions, in accordance with an embodiment.

At block 202, the method 200 comprises generating a graph representation of the plurality of pre-selected error-free solutions. At block 204, the method 200 comprises generating a graph representation of the submitted solution. In an embodiment, the aforementioned operations are performed by a graph representation (GR) generator 102. More specifically, the method 200 comprises generating, by the graph representation (GR) generator 102, a graph representation of the plurality of pre-selected error-free solutions and the submitted solution.

At block 206, the method 200 comprises selecting a graph representation of an error-free solution from the plurality of pre-selected error-free solutions with the minimal distance from the graph representation of the submitted solution. In an embodiment, the operation of selection is performed by a selector 104. In an embodiment, the selector 104 is configured to select a graph representation of the error-free solution which has a minimal distance to the graph representation of the submitted solution. In an embodiment, the minimal distance can be a threshold distance for the selector 104 for making an appropriate selection of the closest error-free solution to the submitted solution. In an embodiment, the method 200 comprises using a thinning algorithm to select the graph representation of the selected error-free solution.

At block 208, the method 200 comprises comparing the graph representation of the submitted solution to the graph representation of the selected error-free solution. In an embodiment, the operation of comparing is performed by a comparator 108.

At block 210, the method 200 comprises identifying the difference between the graph representations of the submitted solution and the graph representation of the selected error-free solution. In an embodiment, the operation of identifying is performed by a result computing unit 110.

At block 212, the method 200 comprises mapping the difference between the graph representations of the submitted solution and the graph representation of the selected error-free solution to the submitted solution and the selected error-free solution. In an embodiment, the operation of mapping is performed by the result computing unit 110.

At block 214, the method 200 comprises displaying, using a graphical user interface or printing on a media such as paper, the difference between the submitted solution and the selected error-free solution as an explanation of an error in the submitted solution. In an embodiment, the operation of displaying is performed by the result computing unit 110.

In an embodiment, the method 200 further comprises assigning, by a score generator 112, a score to the submitted solution that is reverse correlated to the number of differences between the submitted solution and the selected error-free solution.

In an embodiment, the method 200 comprises using a classifier 114 for classifying the errors based on prior classification of errors. In an embodiment, the classifier 114 is at least one of a machine learning artificial intelligence (AI) system and an expert AI system. In an embodiment, the memory 106 can include the dataset of error classifications for allowing the system to compare the detected errors with the dataset of error classifications for classifying the detected errors.

Thus, improvements in computerized graph representation technology are achieved. In particular, embodiments implement optimizations and efficiencies in automatically finding a similar graph where source code is stored in memory as a graph. A technical problem exists in how to identify similarities between graphs. Embodiments solve this problem based on a closest similar graph.

A further technical problem exists in how to identify deficiencies in graphs. Accordingly, the identified closest similar graph is used as a basis for further deficiency calculation operations. Specifically, by using a closest similar graph compared to a graph under test, certain parts of a graph that are identical or equivalent (e.g. similar or similarly-operating code) can be eliminated from further memory and processing, thereby increasing efficiencies in computerized graph technology. Thus, node and edge calculation evaluations for graph deficiencies (e.g. on the closest similar graph) are improved because a plurality of graphs have already been reduced to the closest similar graph.

Embodiments described herein thereby decrease the amount of source code that needs to be reviewed by the examiner to identify an error in a submitted solution. Instead of reviewing the entire source code of the submitted solution, the examiner is presented with only the source code that is related to the differences between the graph of the closest correct solution and the graph of the submitted solution.

The operations in the process that are related to graph processing, specifically, selecting the graph of a solution known to be correct and the graph of the submitted solution and subsequently selecting differences between them, highlights only the graphical representations of the source code that point to elements in the source code that are different.

The operation of selecting the closest graphs is designed to minimize the amount of source code to review by selecting the solution known to be correct that implements the closest algorithm within its solution. By such operation, it is intended that the submitted solution contains only minor errors compared to that closest solution known to be correct.

The second operation identifies these differences and maps these differences to the source code that can be reviewed by the submitter or the reviewer.

1. A method for identification and classification of errors in a submitted solution using a collection of pre-selected error-free solutions, the method comprising:
generating a graph representation of the plurality of pre-selected error-free solutions and a graph representation of the submitted solution, in any order;
selecting a graph representation of an error-free solution from the plurality of pre-selected error-free solutions with a minimal distance from the graph representation of the submitted solution;
comparing the graph representation of the submitted solution to the graph representation of the selected error-free solution;
identifying a difference between the graph representation of the submitted solution and the graph representation of the selected error-free solution;
mapping the difference between the graph representation of the submitted solution and the graph representation of the selected error-free solution to the submitted solution to source code fragments from the submitted solution and the selected error-free solution from which the nodes and edges comprising the difference were generated; and
displaying, using a graphical user interface, the difference between the submitted solution and the selected error-free solution as an explanation of an error in the submitted solution.

2. The method of claim 1, wherein the distance between graphs is the Graph Edit Distance (GED).

3. The method of claim 1, wherein selecting the graph representation of the selected error-free solution further comprises using a thinning algorithm to select the graph representation of the selected error-free solution.

4. The method of claim 1, wherein the identifying the difference between the graph representation of the submitted solution and the graph representation of the selected error-free solution further comprises assigning a score to the submitted solution.

5. The method of claim 4, wherein the score is in inverse correlation with the number of differences between the graphs of the submitted solution and the selected error-free solution.

6. The method of claim 4, wherein the graph of the software source code is at least one of an Abstract Syntax Tree (AST), a Control Flow Graph (CFG), a Program Dependence Graph (PDG), and a Code Property Graphs (CPG).

7. The method of claim 1, wherein the identifying the difference between the graph representations of the submitted solution and the graph representation of the selected error-free solution further comprises classifying the errors based on prior classification of errors using at least one of a machine learning artificial intelligence (AI) system and an expert AI system.

8. A system for identification and classification of errors in a submitted solution using a collection of pre-selected error-free solutions, the system comprising:
at least one processor and a memory operably coupled to the at least one processor;
a graph representation (GR) generator including instructions that, when executed by the at least one processor, cause the processor to generate a graph representation of the plurality of pre-selected error-free solutions and the submitted solution;
a selector including instructions that, when executed by the at least one processor, cause the processor to select graph representation of an error-free solution from the plurality of pre-selected error-free solutions with a minimal distance from the graph representation of the submitted solution;
a comparator including instructions that, when executed by the at least one processor, cause the processor to compare the graph representation of the submitted solution to the graph representation of the selected error-free solution; and
a result computing unit including instructions that, when executed by the at least one processor, cause the processor to:
identify a difference between the graph representation of the submitted solution and the graph representation of the selected error-free solution;
map a difference between the graph representations of the submitted solution and the graph representation of the selected error-free solution to source code fragments from the submitted solution and the selected error-free solution from which the nodes and edges comprising the difference were generated; and
display, using a graphical user interface, the difference between the submitted solution and the selected error-free solution as an explanation of an error in the submitted solution.

9. The system of claim 8, wherein the submitted solution is a computer source code.

10. The system of claim 8, wherein the selector is further configured to use a thinning algorithm to select the graph representation of the selected error-free solution.

11. The system of claim 8, further comprises a score generator including instructions that, when executed by the at least one processor, cause the processor to assign a score to the submitted solution.

12. The system of claim 13, wherein the score is inverse correlated to the number of identified differences between the graph of the submitted solution and the graph of the selected error-free solution.

13. The system of claim 8, wherein the graph of the software source code is an Abstract Syntax Tree (AST), a Control Flow Graph (CFG), a Program Dependence Graph (PDG), or a Code Property Graphs (CPG).

14. The system of claim 8, wherein the distance between graphs is the Graph Edit Distance (GED).

15. The system of claim 8, further comprising a classifier including instructions that, when executed by the at least one processor, cause the processor to classify the errors based on prior classification of errors using at least one of a machine learning artificial intelligence (AI) system and an expert AI system.
